(19) United States
(12) Patent Application Publication
(10) Pub. No.: US 2022/0286953 A1
(43) Pub. Date: Sep. 8, 2022

(54) SLICE SELECTION SUBSCRIPTION DATA ENHANCEMENT

(71) Applicant: Telefonaktiebolaget LM Ericsson (publ), Stockholm (SE)

(72) Inventor: Hongxia Long, Shanghai (CN)

(21) Appl. No.: 17/633,250

(22) PCT Filed: Jul. 24, 2020
(86) PCT No.: PCT/EP2020/070932

§ 371 Date: Feb. 7, 2022

(30) Foreign Application Priority Data
Aug. 9, 2019 (CN) PCT/CN2019/099980

(51) Int. Cl. H04W 48/18; H04W 60/04; H04W 12/06; H04L 9/40

(52) U.S. Cl. CPC H04W 48/18; H04W 60/04; H04W 12/06; H04L 63/0892

(57) ABSTRACT

Embodiments are disclosed herein that relate to enhanced slice-specific selection subscription data indicating whether slice-specific authentication and authorization is required for a wireless device(s). Embodiments of a method of generating, based on the enhanced slice-specific selection subscription data and the slice-specific authentication and authorization, a registration response to a wireless device registration request to access at least one network slice are disclosed.

### TECHNICAL FIELD

Slice selection subscription in access and mobility management (AMF), unified data management (UDM), and 5G Core (5GC).

### BACKGROUND

### Network Slice-Specific Authentication and Authorization (Reproduced From 3GPP TS 23.501 5.15.10)

A serving PLMN shall perform Network Slice-Specific Authentication and Authorization for the S-NSSAIs of the HPLMN which are subject to it based on subscription information. The UE shall indicate in the Registration Request message in the UE 5GMM Core Network Capability whether it supports this feature. If the UE does not support this feature, the AMF shall not trigger this procedure for the UE and if the UE requests these S-NSSAIs that are subject to Network Slice-Specific Authentication and Authorization they are rejected for the PLMN.

If a UE is configured with S-NSSAIs, which are subject to Network Slice-Specific Authentication and Authorization, the UE stores an association between the S-NSSAI and corresponding credentials for the Network Slice-Specific Authentication and Authorization.

NOTE: The credentials for Network Slice-Specific Authentication and Authorization and how to provision them in the UE are not specified.

To perform the Network Slice-Specific Authentication and Authorization for an S-NSSAI, the AMF invokes an EAP-based Network Slice-Specific authorization procedure documented in TS 23.502 [3] clause 4.2.9 (see also TS 33.501 [29]) for the S-NSSAI.

This procedure can be invoked for a supporting UE by an AMF at any time, e.g., when:

a. The UE registers with the AMF and one of the S-NSSAIs of the HPLMN which maps to an S-NSSAI in the Requested NSSAI is requiring Network Slice-Specific Authentication and Authorization (see clause 5.15.5.2.1 for details); or
b. The Network Slice-Specific MA Server triggers a UE re-authentication and re-authorization for an S-NSSAI; or
c. The AMF, based on operator policy or a subscription change, decides to initiate the Network Slice-Specific Authentication and Authorization procedure for a certain S-NSSAI which was previously authorized.
In the case of re-authentication and re-authorization (b. and c. above) the following applies:
If S-NSSAIs that are requiring Network Slice-Specific Authentication and Authorization are included in the Allowed NSSAI for each Access Type, AMF selects an Access Type to be used to perform the Network Slice-specific Authentication and Authorization procedure based on network policies.
If the Network Slice-Specific Authentication and Authorization for some S-NSSAIs in the Allowed NSSAI is unsuccessful, the AMF shall update the Allowed NSSAI for each Access Type to the UE via UE Configuration Update procedure.
If the Network Slice-Specific Authentication and Authorization fails for all S-NSSAIs in the Allowed NSSAI, the AMF shall execute the Network-initiated Deregistration procedure described in TS 23.502 [3], clause 4.2.2.3.3, and shall include in the explicit De-Registration Request message the list of Rejected S-NSSAIs, each of them with the appropriate rejection cause value.

After a successful or unsuccessful UE Network Slice-Specific Authentication and Authorization, the UE context in the AMF shall retain the authentication and authorization status for the UE for the related specific S-NSSAI of the HPLMN while the UE remains RM-REGISTERED in the PLMN, so that the AMF is not required to execute a Network Slice-Specific Authentication and Authorization for a UE at every Periodic Registration Update or Mobility Registration procedure with the PLMN.

A Network Slice-Specific MA server may revoke the authorization or challenge the authentication and authorization of a UE at any time. When authorization is revoked for an S-NSSAI that is in the current Allowed NSSAI for an Access Type, the AMF shall provide a new Allowed NSSAI to the UE and trigger the release of all PDU sessions associated with the S-NSSAI, for this Access Type.

The AMF provides the General Public Subscription Identifier (GPSI) of the UE related to the S-NSSAI to the Authentication, Authorization and Accounting (AM) Server to allow the AAA server to initiate the Network Slice-Specific Authentication and Authorization, or the Authorization revocation procedure, where the UE current AMF needs to be identified by the system, so the UE authorization status can be challenged or revoked.

The Network Slice-Specific Authentication and Authorization requires that the UE Primary Authentication and Authorization of the Subscription Permanent Identifier (SUPI) has successfully completed. If the SUPI authorization is revoked, then also the Network Slice-Specific authorization is revoked.

### FIG. 1

### Slice Selection Subscription Data Retrieval (Reproduced From 3GPP TS 29.503 5.2.2.2.2)

FIG. 1 shows a scenario where the NF service consumer (e.g., AMF) sends a request to the

UDM to receive the UE's NSSAI (see also 3GPP TS 23.502 FIG. 4.2.2.2.3-1 step 3). The request contains the UE's identity (/{supi}), the type of the requested information (/nssai) and query parameters (supported-features, plmn-id).

1. The NF service consumer (e.g., AMF) sends a GET request to the resource representing the UE's subscribed NSSAI, with query parameters indicating the supported-features and/or plmn-id.
2a. On success, the UDM responds with “200 OK” with the message body containing the UE's NSSAI as relevant for the requesting NF service consumer.
2b. If there is no valid subscription data for the UE, HTTP status code “404 Not Found” shall be returned including additional error information in the response body (in the “ProblemDetails” element).
On failure, the appropriate HTTP status code indicating the error shall be returned and appropriate additional error information should be returned in the GET response body.

The Nssai data model returned (in step 2a, above) is shown in Table 6.1.6.2.2-1

TABLE 6.1.6.2.2-1
Definition of type Nssai

| Attribute name | Data type | P | Cardinality | Description |
|---|---|---|---|---|
| supportedFeatures | SupportedFeatures | O | 0 . . . 1 | See clause 6.1.8 |
| defaultSingleNssais | array(Snssai) | M | 1 . . . N | A list of Single Nssais used as default |
| singleNssais | array(Snssai) | O | 1 . . . N | List of non default Single Nssais. |

There is a problem with UEs having unauthorized access to an S-NSSAI and authorized UEs being denied access due to the unauthorized UEs.

### SUMMARY

Embodiments are disclosed herein that relate to enhanced slice-specific selection subscription data indicating whether slice-specific authentication and authorization is required for a wireless device(s). Embodiments of a method of generating, based on the enhanced slice-specific selection subscription data and the slice-specific authentication and authorization, a registration response to a wireless device registration request to access at least one network slice are disclosed.

Embodiments of methods of operation of a system of core network entities are disclosed that include providing, storing, retrieving, and using enhanced slice selection subscription data, which indicates whether a UE is subject to a network slice-specific authentication and authorization for access to a slice, to trigger network slice-specific authentication and authorization to prevent unauthorized UE access to a slice.

Embodiments of a method of operation of a UDM are disclosed for the UDM to provide the enhanced slice selection subscription data with indication of whether a network slice is subject to network slice-specific authentication and authorization or not. In some embodiments, these embodiments further include a sub-method that if the slice selection subscription information related to slice-specific authentication and authorization is changed then notify AMF.

Embodiments of a method of operation of a UDR to process the provisioning and store the enhanced slice selection subscription data with indication of whether a network slice is subject to network slice-specific authentication and authorization or not are disclosed. In some embodiments, these embodiments further include a sub-method that if the slice selection subscription information related to slice-specific authentication and authorization is changed then notify UDM, so UDM could further notify AMF as descried above

Embodiments of a method of operation of an AMF to retrieve of the enhanced slice selection subscription data from UDM are disclosed. In some embodiments, the AMF depends on the indication of whether a network slice is subject to network slice-specific authentication and authorization or not to trigger the slice-specific authentication and authorization for S-NSSAIs. In some embodiments, these embodiments further include a sub-method that if get notified by the UDM the slice selection subscription change of the slice-specific authentication and authorization re-evaluate the condition and trigger slice-specific authentication or authorization accordingly.

In some embodiments, slice selection subscription data is enhanced to support indication of whether slice-specific authentication and authorization is required or not for S-NSSAIs. In this manner, once an AMF gets the information, the AMF can decide whether to trigger the slice-specific authentication or authentication for those S-NSSAIs subject to network slice-specific authentication and authorization.

In some embodiments, if network slice-specific authentication and authorization is performed for those S-NSSAIs subject to network slice-specific authentication and authorization, UEs can only access the network slice(s) that those UEs are entitled to access. Checking for and performing slice-specific authentication and authorization prevents unauthorized UEs from consuming resources of the Network Slice and potential DoS to legitimate UEs.

Embodiments of a core network node in a communication system are disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a procedure for slice selection subscription data retrieval (from 3GPP TS 29.503 5.2.2.2.2). In one embodiment, to perform a service for a UE, a Network Function (NF) Service Consumer requires features of a particular type of network slice. In the illustrated embodiment in FIG. 1, the NF Service Consumer is requesting a UE's NSSAI from a UDM to identify the network slices available for UE access.

FIG. 5 illustrates a procedural flow for provisioning of enhanced user slice-specific selection subscription data.

FIGS. 6A and 6B illustrate a procedure for network slice-specific authentication and authorization based on enhanced user slice selection subscription data.

FIG. 7 illustrates a procedure for a network slice-specific authentication and authorization triggered by an enhanced user slice selection subscription data change.

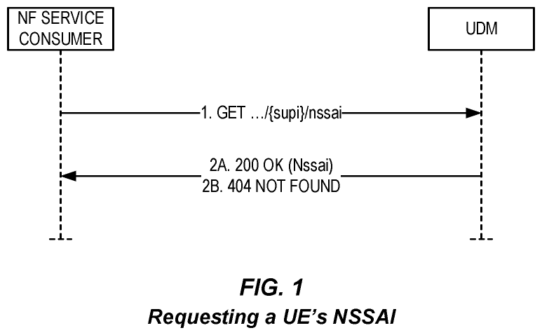

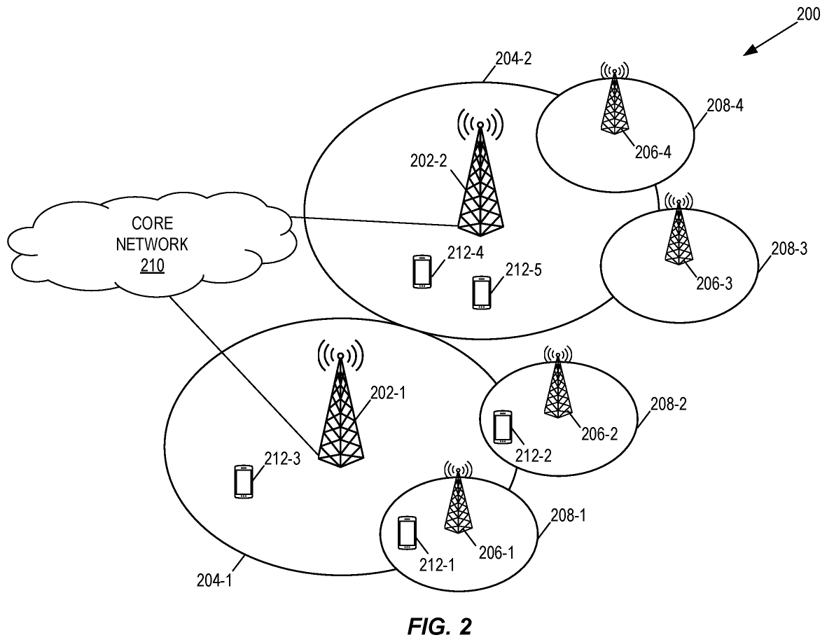

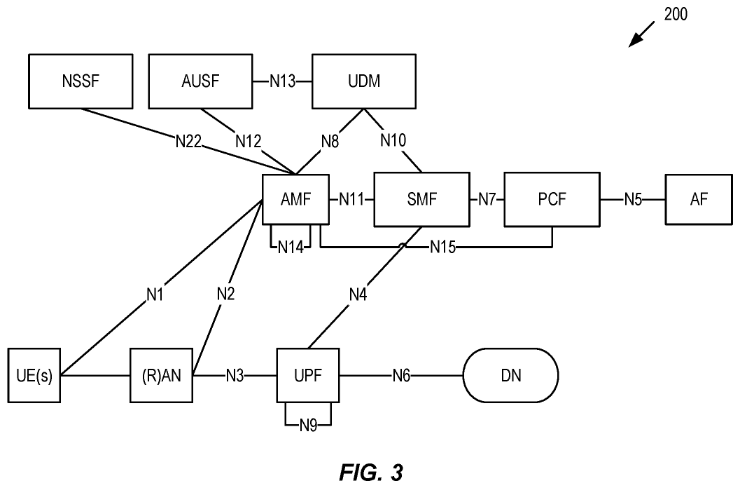

FIG. 2 illustrates one example of a cellular communications network according to some embodiments of the present disclosure;

FIG. 8 is a schematic block diagram of a radio access node according to some embodiments of the present disclosure;

FIG. 9 is a schematic block diagram that illustrates a virtualized embodiment of the radio access node of FIG. 8 according to some embodiments of the present disclosure;

FIG. 10 is a schematic block diagram of the radio access node of FIG. 8 according to some other embodiments of the present disclosure;

FIG. 11 is a schematic block diagram of a User Equipment device (UE) according to some embodiments of the present disclosure;

FIG. 12 is a schematic block diagram of the UE of FIG. 11 according to some other embodiments of the present disclosure;

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The slice selection subscription data provided by a Unified Data Management (UDM) to an Access Management Function (AMF) does not contain any indication of whether a network slice is subject to network slice-specific authentication and authorization or not. When the AMF gets the slice selection subscription data from UDM, the AMF has no indication whether to trigger the network slice-specific authentication and authorization procedure for UE requested S-NSSAIs.

If network slice-specific authentication and authorization is not performed for those S-NSSAIs subject to network slice-specific authentication and authorization, unauthorized UEs may access the network slice that those UEs are not entitled to access. The unauthorized UEs may consume resources of the Network Slice and they may cause Denial-of-Service (DoS) to legitimate UEs.

Embodiments are disclosed that relate to enhanced slice-specific selection subscription data indicating whether slice-specific authentication and authorization is required for a wireless device(s). Embodiments of a method of generating, based on the enhanced slice-specific selection subscription data and the slice-specific authentication and authorization, a registration response to a wireless device registration request to access at least one network slice are also disclosed. Embodiments of a method of triggering slice-specific authentication and authorization in response to a change to the enhanced slice-specific selection subscription data are also disclosed.

A first embodiment includes a method in a UDM to provide the enhanced slice selection subscription data with indication of whether a network slice is subject to network slice-specific authentication and authorization or not, which further include a sub-method that if the slice selection subscription information related to slice-specific authentication and authorization is changed then notify AMF.

Additional embodiments include methods of UDR to process the provisioning and store the enhanced slice selection subscription data with indication of whether a network slice is subject to network slice-specific authentication and authorization or not, which further include a sub-method that if the slice selection subscription information related to slice-specific authentication and authorization is changed, then notify UDM, so UDM could further notify AMF as described above.

Further embodiments include methods of AMF to retrieve the enhanced slice selection subscription data from UDM and, depending on the indication of whether a network slice is subject to network slice-specific authentication and authorization or not, to trigger the slice-specific authentication and authorization for S-NSSAIs, which further include a sub-method that if the AMF gets notified by the UDM of a slice selection subscription change, the slice-specific authentication and authorization re-evaluates the condition and triggers slice-specific authentication or authorization accordingly.

Slice selection subscription data is enhanced to support an indication of whether slice-specific authentication and authorization is required or not for S-NSSAIs, so that once the AMF gets the information it can decide whether to trigger the slice-specific authentication and authorization for those S-NSSAIs subject to network slice-specific authentication and authorization.

If network slice-specific authentication and authorization is performed for those S-NSSAIs subject to network slice-specific authentication and authorization, only authorized UEs could access the network slice which those UEs are entitled to access. Checking for and performing slice-specific authentication and authorization prevents unauthorized UEs from consuming resources of the Network Slice and potential DoS to authorized UEs.

### FIG. 2

FIG. 2 illustrates one example of a cellular communications system 200 in which embodiments of the present disclosure may be implemented. In the embodiments described herein, the cellular communications system 200 is a 5G system (5GS). In this example, the RAN includes base stations 202-1 and 202-2, which in 5G NR are referred to as gNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G core (5GC). The base stations 202 (and optionally the low power nodes 206) are connected to the core network 210.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs.

### FIG. 3

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side, the 5G network architecture shown in FIG. 3 comprises a plurality of User Equipment (UEs) connected to either a Radio Access Network (RAN) or an Access Network (AN) as well as an Access and Mobility Management Function (AMF). Typically, the (R)AN comprises base stations, e.g., such as evolved Node Bs (eNBs) or NR base stations (gNBs) or similar. Seen from the core network side, the 5G core NFs shown in FIG. 3 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating the user plane and control plane. The user plane carries user traffic while the control plane carries signaling in the network. In FIG. 3, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in

FIG. 3. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

### FIG. 4

FIG. 4 illustrates a 5G network architecture using service-based interfaces between the NFs in the control plane, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service-based interfaces are indicated by the letter “N” followed by the name of the NF, e.g., Namf for the service based interface of the AMF and Nsmf for the service based interface of the SMF, etc. The Network Exposure Function (NEF) and the Network Function (NF) Repository Function (NRF) in FIG. 4 are not shown in FIG. 3 discussed above. However, it should be clarified that all NFs depicted in FIG. 3 can interact with the NEF and the NRF of FIG. 4 as necessary, though not explicitly indicated in FIG. 3.

Some properties of the NFs shown in FIGS. 3 and 4 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

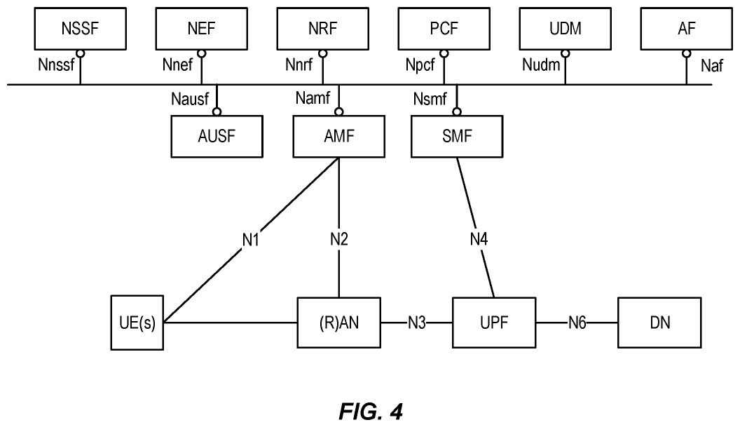

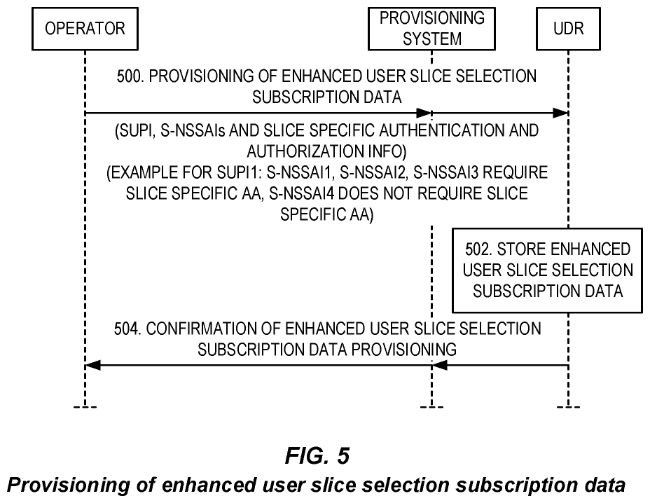

### FIG. 5

FIG. 5 depicts the procedural flow for provisioning the user slice selection subscription data with enhancement data regarding network slice-specific authentication and authorization information.

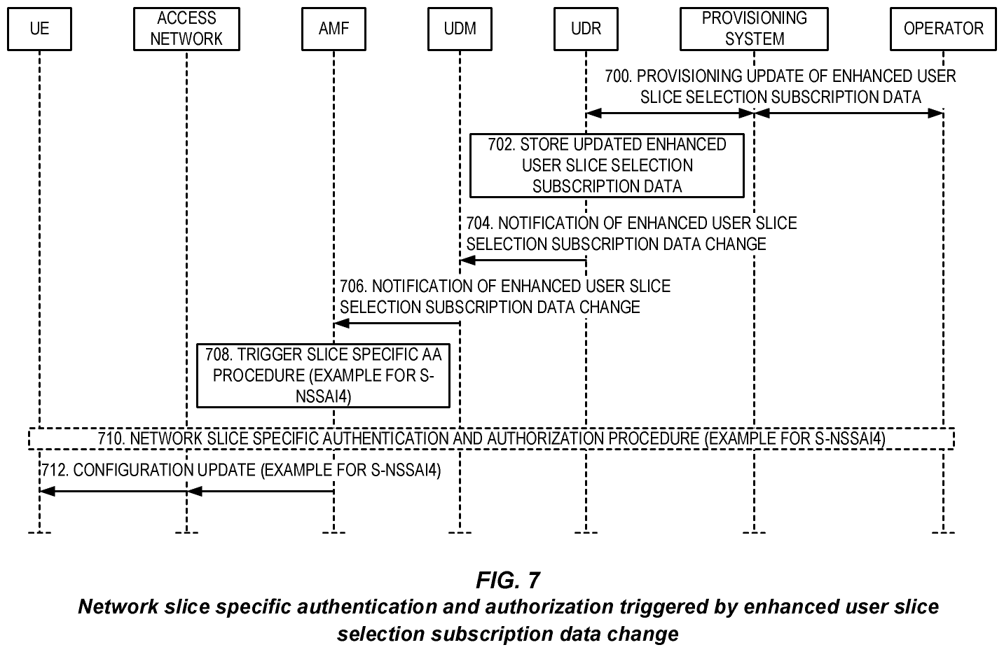

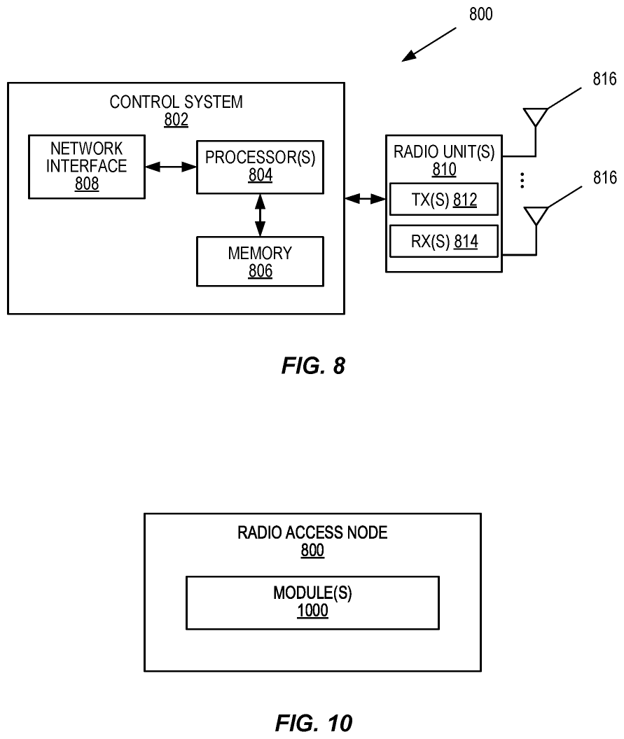

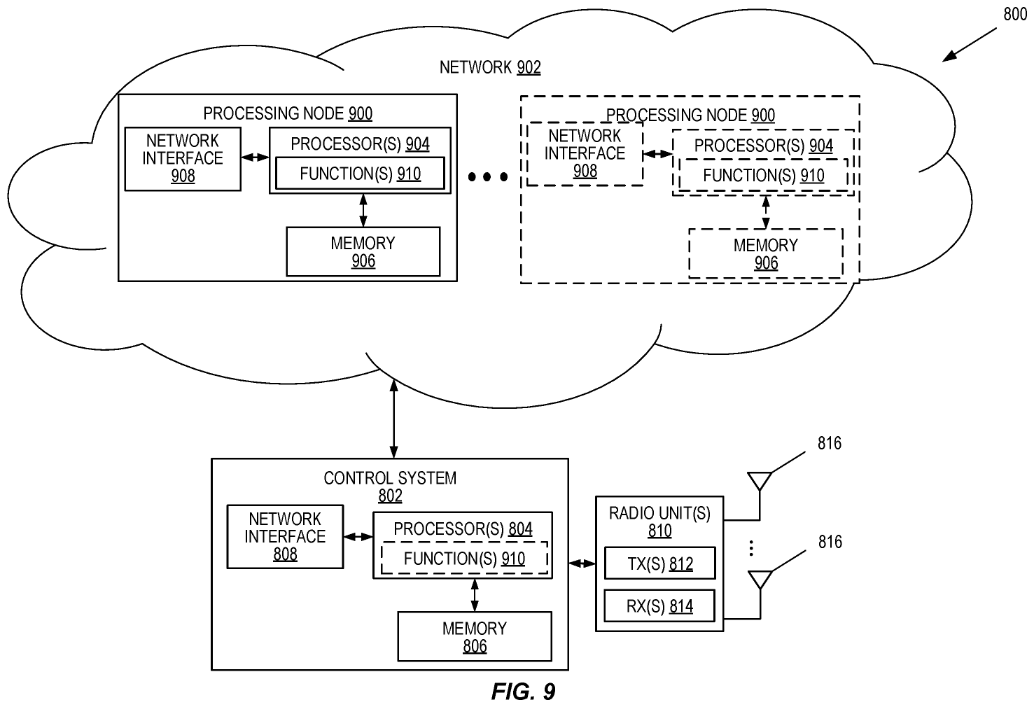

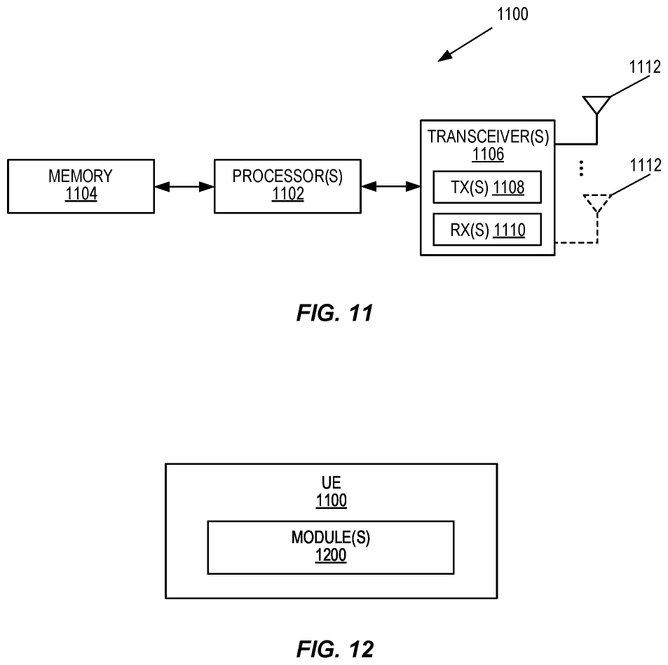

In some embodiments, the disclosed method of operation of a UDR provides a process for provisioning and storing enhanced slice selection subscription data with an indication of whether a network slice is subject to network slice-specific authentication and authorization or not. In some embodiments, the method further includes a sub-method depicted in FIG. 7 wherein, if the slice selection subscription information related to slice-specific authentication and authorization is changed, then the UDM is notified such that the UDM can further notify the AMF.

As illustrated in the example embodiment of FIG. 5, a network operator provisions enhanced user slice selection subscription data related to the network slice-specific authentication and authorization into the UDR through a provisioning system (step 500). The user slice selection subscription data is, in this example, based on user identity such as SUPI, which has a correlation to GPSI in the format of MSISDN, external identity, etc. As discussed herein, the enhanced slice selection subscription data includes data for one or more network slices where, for at least one of those network slices, the data further includes information that indicates whether network slice-specific authentication and authorization is required for that network slice.

The UDR receives the enhanced slice selection subscription data from the network operator via the provisioning system (e.g., in a provisioning request) (step 500).

In the example of FIG. 5:

SUPI: imsi-xxxx, associated GPSI: msisdn-yyyy
List of subscribed S-NSSAIs by the user, among which S-NSSAI4 is the default S-NSSAI:

| | |
|---|---|
| ∘ | S-NSSAI1: |
| | { |
| | “sst”: 2, |
| | “sd”: “URLLC-SD1” |
| | } |
| ∘ | S-NSSAI2: |
| | { |
| | “sst”: 3, |
| | “sd”: “mIOT-SD1” |
| | } |
| ∘ | S-NSSAI3: |
| | { |
| | “sst”: 4, |
| | “sd”: “V2X-SD1” |
| | } |
| ∘ | S-NSSAI4: |
| | { |
| | “sst”: 1, |
| | “sd”: “eMBB-SD1” |
| | } |

And whether the S-NSSAIs are subject to network specific authentication and authorization is defined as below (true means required, false means not required):
S-NSSAI1: true
S-NSSAI2: true
S-NSSAI3: true
S-NSSAI4: false

The UDR stores the enhanced sliced selection subscription data (step 502). More specifically, the UDR processes the provisioning request and persistently stores the enhanced network slice selection subscription data (also referred to herein as enhanced user slice selection subscription data or enhanced user S-NSSAI subscription data), which includes an indication of whether network slice-specific authentication and authorization is required for each S-NSSAI, into a database such that this information can be queried by the UDM in the later phase when handling a request from AMF for getting user S-NSSAI subscription data or user Access and Mobility subscription data.

The UDR feeds back through the provisioning system the enhanced user slice selection subscription data of a provisioning result to the operator as confirmation (step 504). In other words, the

UDR sends a confirmation to the provisioning system and/or the network operator to confirm that the UDR has successfully received and stored the enhanced slice selection subscription data.

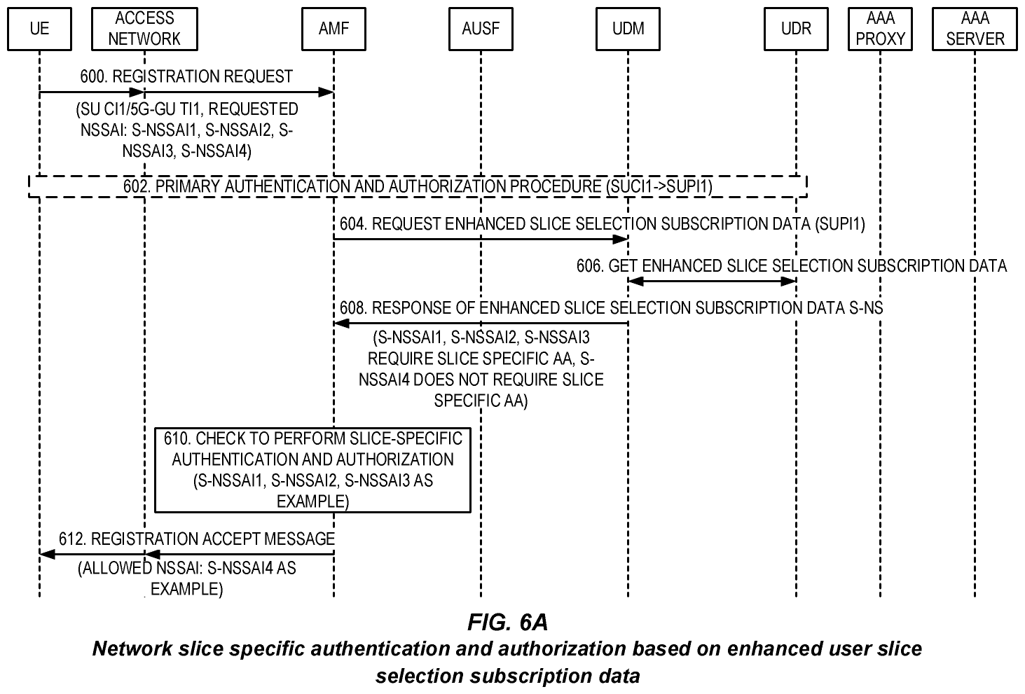

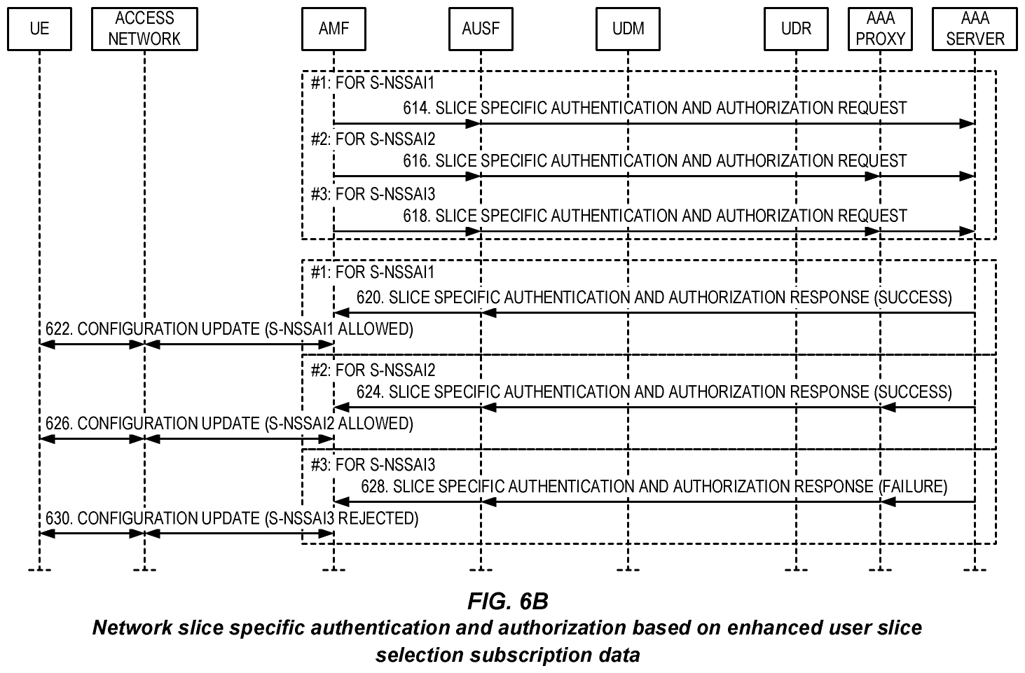

### FIG. 6A and 6B

FIGS. 6A and 6B depict the sequence flow for AMF to trigger the network slice-specific authentication and authorization based on the enhanced user slice selection subscription data from UDM.

The methods of UDM disclosed herein provide the enhanced slice selection subscription data including an indication of whether a network slice is subject to network slice-specific authentication and authorization or not. The disclosed methods further include a sub-method depicted in FIG. 7 wherein if the slice selection subscription information related to slice-specific authentication and authorization is changed, then the UDM is notified such that the UDM can further notify the AMF.

The new methods of AMF disclosed herein retrieve the enhanced slice selection subscription data from UDM and, depending on the indication of whether a network slice is subject to network slice-specific authentication and authorization or not, trigger the slice-specific authentication and authorization for S-NSSAIs. The disclosed methods further include a sub-method depicted in FIG. 7 wherein if AMF gets notified by the UDM of a slice selection subscription change, the slice-specific authentication and authorization re-evaluates the condition and triggers slice-specific authentication or authorization accordingly.

Step 600: UE sends the registration request to AMF core network node through the access network (AN), the information contained in the request includes the user identity such as SUPI or 5G-GUTI, and the requested NSSAI, for example, S-NSSAI1, S-NSSAI2, S-NSSAI3, and S-NSSAI4 as defined in FIG. 5 step 500. In some embodiments, the UE is a wireless device configured to send, to a first network node, a registration request for access to at least two network slices.

The UE indicates in the Registration Request message in the UE 5GMM Core Network Capability whether it supports Network Slice-Specific Authentication and Authorization. If the UE does not support this feature, the AMF does not trigger this procedure for the UE, and if the UE requests these S-NSSAIs that are subject to Network Slice-Specific Authentication and Authorization, they are rejected for the PLMN.

For simplicity, in later steps of the flow in FIGS. 6A and 6B it is assumed that the UE therein supports the Network Slice-Specific Authentication and Authorization feature.

It is also possible that the requested S-NSSAIs may need to be mapped to the HPLMN subscribed S-NSSAIs, but for simplicity it is assumed the mapping is straight forward as standardized sst values are used in the examples.

In other embodiments, the AMF is configured to receive a registration request for accessing at least one network slice.

Step 602: [Optional] In an initial registration in which the user identity is SUCI, AMF decides to trigger the primary authentication and authorization procedure for the PLMN access. Once authenticated by the network, the corresponding SUPI for this SUCI is returned and AMF could keep the mapping in the context. If not the initial registration, and the user identity is 5G-GUTI, AMF could get the SUPI from the AMF context by 5G-GUTI and skip the primary authentication and authorization procedure. In some embodiments, any of the AMF, UDM, UDR, and the wireless device are configured to perform a primary authentication and authorization procedure as illustrated in FIG. 6A.

Step 604: AMF requests the enhanced user slice selection subscription data from the UDM. For example, in some embodiments, the AMF sends a request for the enhanced slice selection subscription data for the wireless device to the UDM. This request can only get the enhanced slice selection subscription data or can get the user access and mobility management data which contains the enhanced slice selection subscription data.

In other embodiments, the UDM is configured to receive, from the AMF, a request for enhanced slice selection subscription data for at least one network slice, and the enhanced slice selection subscription data indicates whether slice-specific authentication and authorization is required for registration on the at least one network slice.

Step 606: UDM queries UDR for the enhanced user slice selection subscription data. In some embodiments, the UDM sends, to a network node (e.g., UDR), a request for the enhanced slice selection subscription data, and receives, from the network node, the enhanced slice selection subscription data. In other embodiments, a UDR receives, from the UDM, a request for enhanced slice selection subscription data for at least one network slice, and sends, to the UDM, the enhanced slice selection subscription data for the at least one network slice.

Step 608: UDM returns enhanced user slice selection subscription data to AMF. UDM includes the information of whether network slice-specific authentication and authorization is required for each subscribed S-NSSAI. In some embodiments, the UDM sends, to the AMF, the enhanced slice selection subscription data.

Conventional methods of signaling do not provide the above information to AMF, so AMF can't, according to conventional methods, trigger network slice-specific authentication and authorization based on user slice selection subscription data.

In the methods disclosed herein, the UDM provides the information of whether network slice-specific authentication and authorization is required for each subscribed S-NSSAI in the enhanced slice selection subscription data to AMF, so AMF can decide whether to trigger the network slice-specific authentication and authorization.

A CR proposal, illustrated below, including attributes for the enhanced slice selection subscription data added to Table 6.1.6.2.2-1 (above) in a backward compatible way, is as follows:

| Attribute name | Data type | P | Cardinality | Description |
|---|---|---|---|---|
| supportedFeatures | SupportedFeatures | O | 0 . . . 1 | See clause 6.1.8 |
| defaultSingleNssais | array(Snssai) | M | 1 . . . N | A list of Single Nssais used as default |
| singleNssais | array(Snssai) | O | 1 . . . N | List of non default Single Nssais. |
| defaultSingleNssaisNssaaIn1fo | array(boolean) | O | 1 . . . N | When present, the defaultSingleNssaisNssaaInfo attribute |
| | | | | contains as many entries as the number of entries in the |
| | | | | defaultSingleNssais attribute. The nth entry in the |
| | | | | defaultSingleNssaisSsaainfo attribute corresponds to the |
| | | | | nth entry in the defaultSingleNssais attribute. |
| | | | | For each element in defaultSingleNssais, indicates whether |
| | | | | subject to Network Slice-Specific Authentication and |
| | | | | Authorization: |
| | | | | true: subject to network slice-specific |
| | | | | authentication and authorization |
| | | | | false: not subject to network slice-specific authentication |
| | | | | and authorization |
| singleNssaissNssaaInfo | array(boolean) | O | 1 . . . N | When present, the singleNssaissNssaaInfo attribute |
| | | | | contains as many entries as the number of entries in the |
| | | | | singleNssais attribute. The nth entry in the |
| | | | | singleNssaissSsaaInfo attribute corresponds to the nth |
| | | | | entry in the singleNssais attribute. |
| | | | | For element in singleNssais, indicates whether subject to |
| | | | | Network Slice-Specific Authentication and Authorization: |
| | | | | true: subject to network slice-specific |
| | | | | authentication and authorization |
| | | | | false: not subject to network slice-specific |
| | | | | authentication and authorization |

Attributes defaultSingleNssaisNssaaInfo and singleNssaissNssaaInfo have been added.

In particular embodiments, the AMF obtains, from the UDM, the enhanced slice selection subscription data by receiving the enhanced slice selection subscription data from the UDM.

As an example, in the response from UDM to AMF:

defaultSingleNssais only contains S-NSSAI4;
singleNssais contains S-NSSAI1, S-NSSAI2, and S-NSSAI3;
defaultSingleNssaisNssaaInfo contains false, which means S-NSSAI4 isn't subject to network slice-specific authentication and authorization; and
singleNssaissNssaaInfo contains {true, true, true} which means S-NSSAI1, S-NSSAI2, and S-NSSAI3 are subject to network slice-specific authentication and authorization.

Step 610: AMF parses the enhanced user slice selection subscription data to decide whether to trigger network slice-specific authentication and authorization for each requested S-NSSAI.

As an example, S-NSSAI1, S-NSSAI2, and S-NSSAI3 are subject to slice-specific authentication and authorization. In one example disclosed herein, the AMF determines, based on the enhanced sliced subscription data, whether slice-specific authentication and authorization is required for registration on the at least one network slice.

Step 612: AMF sends registration accept message to UE through access network. In an example, the allowed NSSAI only contains S-NSSAI4 as it is subscribed by the user and network slice-specific authentication and authorization is not required. In a particular embodiment, the AMF sends, to a wireless device, a registration response for at least a first one of the at least one network slice (e.g., indicated in the registration request in step 600). In another embodiment, the UE receives, from the AMF, a registration response indicating whether the wireless device registration is authorized to access a first one of at least two network slices.

Step 614: AMF triggers network slice-specific authentication and authorization for S-NSSAI1, S-NSSAI2, and S-NSSAI3 as network slice-specific authentication and authorization are required. In some embodiments, the AMF sends, to a third network node (e.g., AAA server), a slice-specific authentication and authorization request for each of the at least one network slice (e.g., identified in the registration request). In an example, the slice-specific authentication and authorization request is sent to the AAA server in response to determining (e.g., in step 610) that the slice-specific authentication and authorization is required for at least one network slice.

AMF sends the slice-specific authentication and authorization request for S-NSSAI1, as an example, through AUSF to AM server for cases in which AM Server (AAA-S) is hosted by the H-PLMN operator.

Step 616: AMF sends the slice-specific authentication and authorization request for S-NSSAI2, as an example, through AUSF and AM proxy to AM server for cases in which an MA Proxy (MA-P) in the serving PLMN may be involved, e.g., if the AAA Server belongs to a third party.

Step 618: AMF sends the slice-specific authentication and authorization request for S-NSSAI3, as an example, through AUSF and AM proxy to AM server for cases in which a MA Proxy (AAA-P) in the serving PLMN may be involved, e.g., if the MA Server belongs to a third party.

Step 620: AMF gets the result of the slice-specific authentication and authorization for S-NSSAI1, as an example, from AM server and AUSF to AMF indicating success.

In some embodiments, step 620 includes the AMF receiving from the UDM, an authorization response to the slice-specific authentication and authorization request for each of the at least one network slice, the authorization response indicating whether the wireless device is registered to access the respective network slice.

Step 622: AMF sends the UE configuration update to UE through the access network, as an example, to update the allowed NSSAI to include S-NSSAI1 as allowed. In some embodiments, the AMF sends, to the wireless device, a registration response for at least one of the at least one network slice.

Step 624: AMF gets the result of the slice-specific authentication and authorization for S-NSSAI2, as an example, from AM server, through AAA proxy and AUSF to AMF indicating success.

Step 626: AMF sends the UE configuration update to UE through the access network, as an example, to update the allowed NSSAI to include S-NSSAI2 as allowed.

Step 628: AMF gets the result of the slice-specific authentication and authorization for S-NSSAI3, as an example, from AM server, through AAA proxy and AUSF to AMF indicating failure.

Step 630: AMF sends the UE configuration update to UE through the access network, as an example, to update the allowed NSSAI to include S-NSSAI3 as rejected and indicate the cause. In some embodiments, the UE is configured to receive from the first network node, a registration response for at least one of the at least one network slice.

It is noted that, in one example, the network slice-specific authentication and authorization result for S-NSSAI1, S-NSSAI2, and S-NSSAI3 are updated to UE separately. In another example, multiple results are contained in one configuration update to UE.

### FIG. 7

FIG. 7 depicts the sequence flow for AMF to trigger the network slice-specific authentication and authorization based on the enhanced user slice selection subscription data change notification from UDM.

Step 700: Operator provisioning, through a provisioning system, the update of the enhanced user slice selection subscription data, for example to change network slice-specific authentication and authorization for N-NSSAI4 from not required to required. In some embodiments, the provisioning includes the UDR receiving, from a network node, an update for the stored enhanced user slice-specific selection subscription data for the at least one network slice.

Step 702: UDR stores the updated enhanced user slice selection subscription data. In some embodiments, the UDR updates the stored enhanced user slice-specific selection subscription data based on the update for the enhanced user slice-specific selection subscription data.

Step 704: UDR notifies UDM of enhanced user slice selection subscription data change. In some embodiments, the UDR sends, to the UDM, a notification of the update of the stored enhanced user slice-specific selection subscription data. In some embodiments, the UDM receives, from the UDR, a notification of an enhanced slice selection subscription data update for the at least one network slice.

Step 706: UDM notifies AMF of enhanced user slice selection subscription data change. In some embodiments, the AMF receives a notification of an update of the enhanced user slice-specific selection subscription data. In some embodiments, the UDM sends, to the AMF, a notification of the update of the enhanced user slice-specific selection subscription data in response to receiving, from the UDR, a notification of an enhanced user slice-specific selection subscription data update for at least one network slice.

Step 708 AMF checks whether to trigger the network slice-specific authentication and authorization (Example for S-NSSAI4). In some embodiments, the AMF determines whether to trigger a slice-specific authentication and authorization for at least one network slice in response to the notification of an update of the enhanced user slice-specific subscription data.

Step 710: Network Slice-Specific authentication and authorization procedure (Example for S-NSSAI4) according to changed enhanced user slice-selection subscription data. In some embodiments, the AMF, UDM, UDR and/or the wireless device perform a network slice-specific authentication and authorization procedure.

Step 712: AMF, based on the network slice-specific authentication and authorization result for S-NSSAI4, sends a configuration update to UE through access network, wherein the update contains the information that S-NSSAI4 is allowed or rejected based on result of step 710. In some embodiments, the AMF sends, to the UE, a configuration update for the at least one network slice. In other embodiments, the UE receives, from the AMF, a configuration update for at least one network slice.

### FIG. 8

FIG. 8 is a schematic block diagram of a radio access node 800 according to some embodiments of the present disclosure. The radio access node 800 may be, for example, a base station 202 or 206. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 includes one or more radio units 810 that each include one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the functions are implemented in software that is stored, e.g., in the memory 806 and executed by the one or more processors 804.

### FIG. 9

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 includes the control system 802 that includes the one or more processors 804 (e.g., CPUs, ASICs, FPGAs, and/or the like), the memory 806, and the network interface 808, and the one or more radio units 810 that each include the one or more transmitters 812 and the one or more receivers 814 coupled to the one or more antennas 816, as described above. The control system 802 is connected to the radio unit(s) 810 via, for example, an optical cable or the like. The control system 802 is connected to one or more processing nodes 900 coupled to or included as part of a network(s) 902 via the network interface 808. Each processing node 900 includes one or more processors 904 (e.g., CPUs, ASICs, FPGAs, and/or the like), memory 906, and a network interface 908.

In this example, functions 910 of the radio access node 800 described herein are implemented at the one or more processing nodes 900 or distributed across the control system 802 and the one or more processing nodes 900 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicates directly with the processing node(s) 900 via an appropriate network interface(s).

In some embodiments, a computer program including instructions which, when executed by at least one processor, cause the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 10

FIG. 10 is a schematic block diagram of the radio access node 800 according to some other embodiments of the present disclosure. The radio access node 800 includes one or more modules 1000, each of which is implemented in software. The module(s) 1000 provides the functionality of the radio access node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

### FIG. 11

FIG. 11 is a schematic block diagram of a UE 1100 according to some embodiments of the present disclosure. As illustrated, the UE 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by one of ordinary skill in the art. The processors 1102 are also referred to herein as processing circuitry. The transceivers 1106 are also referred to herein as radio circuitry. In some embodiments, the functionality of the UE 1100 described above may be fully or partially implemented in software that is, e.g., stored in the memory 1104 and executed by the processor(s) 1102. Note that the UE 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the UE 1100 and/or allowing output of information from the UE 1100), a power supply (e.g., a battery and associated power circuitry), etc.

In some embodiments, a computer program including instructions which, when executed by at least one processor, cause the at least one processor to carry out the functionality of the UE 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 12

FIG. 12 is a schematic block diagram of the UE 1100 according to some other embodiments of the present disclosure. The UE 1100 includes one or more modules 1200, each of which is implemented in software. The module(s) 1200 provides the functionality of the UE 1100 described herein.

### Some Embodiments

Some of the embodiments that have been disclosed above may be summarized in the following manner:
1. A method performed by a core network node (AMF) in a communication system, the method comprising:

receiving (600), from a wireless device, a registration request for accessing at least one network slice;

obtaining (604, 608), from a second network node, enhanced slice selection subscription data for the wireless device, the enhanced slice selection subscription data indicating whether said at least one network slice is subject to network slice-specific authentication and authorization or not;

determining (610), based on the enhanced slice selection subscription data, whether slice-specific authentication and authorization is required for registration on the at least one network slice; and sending (612), to the wireless device, a registration response for at least a first one of the at least one network slice.

2. The method of embodiment 1, wherein obtaining, from the second network node, the enhanced slice selection subscription data for the wireless device comprises:

sending (604) a request for the enhanced slice selection subscription data for the wireless device to the second network node; and

receiving (608) the enhanced slice selection subscription data from the second network node.

3. The method of embodiment 1, further comprising:

in response to determining (610) that the slice-specific authentication and authorization is required for the at least one network slice, sending (614, 616, 618), to a third network node, a slice-specific authentication and authorization request for each of the at least one network slice; and

receiving (620, 624, 628), from the third network node, an authorization response to the slice-specific authentication and authorization request for each of the at least one network slice, the authorization response indicating whether the wireless device is registered to access the respective network slice.

4. The method of embodiment 1, further comprising:

sending (622, 626, 630), to the wireless device, a registration response for at least a second one of the at least one network slice.

5. The method of embodiment 1, further comprising:

performing (602) a primary authentication and authorization procedure in response to receiving the registration request from the wireless device.

6. The method of embodiment 1, further comprising:

performing (710) a network slice-specific authentication and authorization procedure for the at least one network slice.

7. The method of embodiment 1, further comprising:

receiving (706) a notification of an update of the enhanced slice selection subscription data;

in response to the update of the enhanced slice selection subscription data for the at least one network slice, triggering (708) the slice-specific authentication and authorization (710) for the at least one network slice; and

sending (712), to the wireless device, a configuration update for the at least one network slice.

8. A core network node (AMF) in a communication system, the core network node configured to:

receive (600), from a wireless device, a registration request for accessing at least one network slice;

obtain (608), from a second network node, enhanced slice selection subscription data for the wireless device, the enhanced slice selection subscription data indicating whether said at least one network slice is subject to network slice-specific authentication and authorization or not;

determine (610), based on the enhanced slice selection subscription data, whether slice-specific authentication and authorization is required for registration on the at least one network slice; and

send (612), to the wireless device, a registration response for at least a first one of the at least one network slice.

9. The core network node of embodiment 8, wherein to obtain (608), from the second network node, the enhanced slice selection subscription data for the wireless device, the core network node is further configured to:

send (604) a request for the enhanced slice selection subscription data for the wireless device to the second network node; and

receive (608) the enhanced slice selection subscription data from the second network node.

10. The core network node of embodiment 8, further configured to:

in response to determining (610) that the slice-specific authentication and authorization is required for the at least one network slice, send (614, 616, 618), to a third network node, a slice-specific authentication and authorization request for each of the at least one network slice; and

receive (620, 624, 628), from the third network node, an authorization response to the slice-specific authentication and authorization request for each of the at least one network slice, the authorization response indicating whether the wireless device is registered to access the respective network slice.

11. The core network node of embodiment 8, further configured to:

send (622, 626, 630), to the wireless device, a registration response for at least a second one of the at least one network slice.

12. The core network node of embodiment 8, further configured to:

perform (602) a primary authentication and authorization procedure in response to receiving the registration request from the wireless device.

13. The core network node of embodiment 8, further configured to:

perform (710) a network slice-specific authentication and authorization procedure for the at least one network slice.

14. The core network node of embodiment 8, further configured to:

receive (706) a notification of an update of the enhanced slice selection subscription data;

in response to the update of the enhanced slice selection subscription data for the at least one network slice, trigger (708) the slice-specific authentication and authorization (710) for the at least one network slice; and

send (712), to the wireless device, a configuration update for the at least one network slice.

15. The core network node of embodiment 8, comprising an Access Management Function, AMF.
16. A method performed by a core network node (UDM) in a communication system, the method comprising:

receiving (604), from a second network node, a request for enhanced slice selection subscription data for at least one network slice, the enhanced slice selection subscription data indicating whether slice-specific authentication and authorization is required for registration on the at least one network slice;

obtaining (606), from a third network node, the enhanced slice selection subscription data; and

sending (608), to the second network node, the enhanced slice selection subscription data.

17. The method of embodiment 16, wherein obtaining the enhanced slice selection subscription data further comprises:

sending (606), to the third network node, a request for the enhanced slice selection subscription data;

receiving (606), from the third network node, the enhanced slice selection subscription data.

18. The method of embodiment 17, further comprising:

in response to receiving (704), from the third network node, a notification of an enhanced slice selection subscription data update for the at least one network slice, sending (706), to the second network node, a notification of the enhanced slice selection subscription data update.

19. The method of embodiment 17, further comprising:

performing (602) a primary authentication and authorization procedure.

20. The method of embodiment 17, further comprising:

performing (710) a network slice-specific authentication and authorization procedure for the at least one network slice.

21. A core network node (UDM) in a communication system, the core network node configured to:

receive (604), from a second network node, a request for enhanced slice selection subscription data for at least one network slice, the enhanced slice selection subscription data indicating whether slice-specific authentication and authorization is required for registration on the at least one network slice;

obtain (606), from a third network node, the enhanced slice selection subscription data; and

send (608), to the third network node, the enhanced slice selection subscription data.

22. The core network node of embodiment 21, further configured to:

send (606), to the third network node, a request for the enhanced slice selection subscription data; and

receive (606), from the third network node, the enhanced slice selection subscription data.

23. The core network node of embodiment 21, further configured to:

in response to receiving (704), from the third network node, a notification of an enhanced slice selection subscription data update for the at least one network slice, send (706), to the second network node, a notification of the enhanced slice selection subscription data update.

24. The core network node of embodiment 21, further configured to:

perform (602) a primary authentication and authorization procedure.

25. The core network node of embodiment 21, further configured to:

perform (710) a network slice-specific authentication and authorization procedure for the at least one network slice.

26. The core network node of embodiment 21, comprising a Unified Data Management, UDM.
27. A method performed by a core network node (UDR) in a communication system, the method comprising:

storing (502) enhanced slice selection subscription data that indicates whether at least one network slice is subject to network slice-specific authentication and authorization or not;

receiving (606), from a second network node, a request for the enhanced slice selection subscription data for the at least one network slice; and

sending (606), to the second network node, the enhanced slice selection subscription data for the at least one network slice.

28. The method of embodiment 27, further comprising:

receiving (700), from a third network node, an update for the stored enhanced slice selection subscription data for the at least one network slice;

updating (702) the stored enhanced slice selection subscription data based on the update for the enhanced slice selection subscription data; and

sending (704), to the second network node, a notification of the update of the stored enhanced slice selection subscription data.

29. The method of embodiment 27, wherein storing the enhanced slice selection subscription data further comprises:

receiving (500), from a third network node, the enhanced user slice selection subscription data; and

sending (504), to the third network node, confirmation of storing the enhanced slice subscription data.

30. The method of embodiment 27, further comprising:

performing (602) a primary authentication and authorization procedure.

31. The method of embodiment 27, further comprising:

performing (710) a network slice-specific authentication and authorization procedure for the at least one network slice.

32. A core network node (UDR) in a communication system, the core network node configured to:

store (502) enhanced slice selection subscription data that indicates whether at least one network slice is subject to network slice-specific authentication and authorization or not;

receive (606), from a second network node, a request for the enhanced slice selection subscription data for at least one network slice; and

send (606), to the second network node, the enhanced slice selection subscription data for the at least one network slice.

33. The core network node of embodiment 32, further configured to:

receive (700), from a third network node, an update for the stored enhanced slice selection subscription data for the at least one network slice;

update (702) the stored enhanced slice selection subscription data based on the update for the enhanced slice selection subscription data; and

send (704), to the second network node, a notification of the update of the stored enhanced slice selection subscription data.

34. The core network node of embodiment 32, further configured to:

receive (500), from a third network device, the enhanced slice subscription data; and

send (504), to the third network device, confirmation of storing the enhanced slice subscription data.

35. The core network node of embodiment 32, further configured to:

perform (602) a primary authentication and authorization procedure.

36. The core network node of embodiment 32, further configured to:

perform (710) a network slice-specific authentication and authorization procedure for the at least one network slice.

37. The core network node of embodiment 32, comprising a Unified Data Repository, UDR.
38. A method performed in a wireless device in a communication system, the method comprising:

sending (600), to a first network node, a registration request for access to at least two network slices;

receiving (612), from the first network node, a registration response indicating whether the wireless device is authorized to access a first one of the at least two network slices; and

receiving (622, 626, 630) from the first network node, a registration response for at least a second one of the at least two network slices.

39. The method of embodiment 38, further comprising:

receiving (712), from the first network node, a configuration update for at least one of the at least two network slices.

40. A wireless device in a communication system, the wireless device configured to:

send (600), to a first network node, a registration request for access to at least two network slices;

receive (612), from the first network node, a registration response indicating whether the wireless device is authorized to access a first one of the at least two network slices; and

receive (622, 626,630) from the first network node, a registration response for at least a second one of the at least two network slices.

41. The wireless device of embodiment 40, further configured to:

receive (712), from the first network node, a configuration update for at least one of the at least two network slices.

42. A method performed by a communication system, comprising: at a first core network node:

receiving (600), from a wireless device, a registration request for accessing at least one network slice;
obtaining (608), from a second network node, enhanced slice selection subscription data for the wireless device;
determining (610), based on the enhanced slice selection subscription data, whether slice-specific authentication and authorization is required for registration on the at least one network slice; and
sending (612), to the wireless device, a registration response for at least a first one of the at least one network slice;

at the second network node:
receiving (604), from the first core network node, a request for the enhanced slice selection subscription data for the at least one network slice, the enhanced slice selection subscription data indicating whether the slice-specific authentication and authorization is required for registration on the at least one network slice;
sending (606), to a third network node, a request for the enhanced slice selection subscription data;
receiving (606), from the third network node, the enhanced slice selection subscription data; and
sending (608), to the first core network node, the enhanced slice selection subscription data; and

at the third network node:
storing (502) the enhanced slice selection subscription data;
receiving (606), from the second network node, the request for enhanced slice selection subscription data for the at least one network slice; and
sending (606), to the second network node, the enhanced slice selection subscription data for the at least one network slice.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5G-GUTI Fifth Generation Globally Unique Temporary Identifier
AM Authentication, Authorization, and Accounting
AMF Access and Mobility Management Function
AP Access Point
AUSF Authentication Server Function
BSC Base Station Controller
BTS Base Transceiver Station
D2D Device-to-Device
DoS Denial of Service
eNB Enhanced or Evolved Node B
gNB New Radio Base Station
GSM Global System for Mobile Communications
IoT Internet of Things
IP Internet Protocol
LTE Long Term Evolution
M2M Machine-to-Machine
MCE Multi-Cell/Multicast Coordination Entity
MME Mobility Management Entity
MSC Mobile Switching Center
MTC Machine Type Communication
NFV Network Function Virtualization
NR New Radio
NRF Network Function Repository Function
NSSAI Network Slice Selection Assistance Information
O&M Operation and Maintenance
OSS Operations Support System
P-GW Packet Data Network Gateway
RAN Radio Access Network
RAT Radio Access Technology
RNC Radio Network Controller
SCEF Service Capability Exposure Function
SD Slice Differentiator
S-NSSAI Single Network Slice Selection Assistance Information
SST Slice/Service Type
SUPI Subscription Permanent Identifier
UDM Unified Data Management
UDR Unified Data Repository
UE User Equipment
V2V Vehicle-to-Vehicle
V2X Vehicle-to-Everything
VNE Virtual Network Element
VNF Virtual Network Function
VoIP Voice over Internet Protocol
WCDMA Wideband Code Division Multiple Access
WiMax Worldwide Interoperability for Microwave Access

Those skilled in the art will recognize improvements and modifications to the embodiments of the present disclosure. All such improvements and modifications are considered within the scope of the concepts disclosed herein.

1-42. (canceled)

43. A method performed by a core network node in a core network of a communication system additionally comprising a Unified Data Management, UDM, node in the core network the method comprising:
receiving, from a wireless device, a registration request that includes a user identity and one or more requested Single Network Slice Selection Assistance Information, S-Nssais, for identifying and accessing at least one network slice;
obtaining from the UDM node, enhanced slice selection subscription data for the wireless device, the enhanced slice selection subscription data indicating a list of default S-Nssais and a list of non-default S-Nssais, and indicating for each S-Nssai in the list of default S-Nssais and in the list of non-default S-Nssais whether said each S-Nssai is subject to network slice-specific authentication and authorization or not;
determining, based on the enhanced slice selection subscription data, that slice-specific authentication and authorization is required for at least one requested S-Nssai; and then
sending towards an Authentication, Authorization and Accounting, AAA, server, a slice-specific authentication and authorization request for each of the at least one requested S-Nssai;
receiving from the AAA server, an authorization response to the slice-specific authentication and authorization request for each of the at least one requested S-Nssai, the authorization response indicating whether the wireless device is registered to access the respective network slice; and
sending, to the wireless device, a registration response for at least a first one of the at least one network slice.

44. A core network node in a core network of a communication system additionally comprising a Unified Data Management, UDM, node in the core network, the core network node configured to:
receive, from a wireless device, a registration request that includes a user identity and one or more requested Single Network Slice Selection Assistance Information, S-Nssais, for identifying and accessing at least one network slice;
obtain from the UDM node, enhanced slice selection subscription data for the wireless device, the enhanced slice selection subscription data indicating a list of default S-Nssais and a list of non-default S-Nssais, and indicating for each S-Nssai in the list of default S-Nssais and in the list of non-default S-Nssais whether said each S-Nssai is subject to network slice-specific authentication and authorization or not;
determine, based on the enhanced slice selection subscription data, that slice-specific authentication and authorization is required for at least one requested S-Nssai; and then
send towards an Authentication, Authorization and Accounting, AAA, server, a slice-specific authentication and authorization request for each of the at least one requested S-Nssai;
receiving from the AAA server, an authorization response to the slice-specific authentication and authorization request for each of the at least one requested S-Nssai, the authorization response indicating whether the wireless device is registered to access the respective network slice; and
send, to the wireless device, a registration response for at least a first one of the at least one network slice.
